(19) United States
(12) Patent Application Publication
(10) Pub. No.: US 2007/0300273 A1
(43) Pub. Date: Dec. 27, 2007

(54) INTERACTIVE TELEVISION APPLICATION AND CONTENT ENHANCEMENT

(76) Inventor: Gary Turner, Parker, CO (US)

Correspondence Address: SHERIDAN ROSS PC, 1560 BROADWAY, SUITE 1200, DENVER, CO, 80202, US

(21) Appl. No.: 11/622,426

(22) Filed: Jan. 11, 2007

Related U.S. Application Data
(63) Continuation-in-part of application No. 11/425,652, filed on Jun. 21, 2006.
Application No. 11/425,652 is a continuation-in-part of application No. 11/552,047, filed on Oct. 23, 2006.

(51) Int. Cl. H04N 7/173

(52) U.S. Cl. 725/105; 725/136

(57) ABSTRACT

Methods and apparatuses for providing interactive applications along with television broadcasts are provided. More specifically, the applications provided to a user may be related to the broadcast or a commercial and the application may be updated automatically in synchronization with the broadcast. Also, the input of the user may determine how the application is synchronized with the broadcast thereby altering the display and the user experience.

### CROSS-REFERENCE TO RELATED APPLICATIONS

This application is a Continuation-in-Part of U.S. patent application Ser. No. 11/425,652 filed Jun. 21, 2006 and U.S. patent application Ser. No. 11/552,047 filed Oct. 23, 2006, both applications being incorporated herein by reference in their entirety.

### FIELD

The present invention is directed to interactive medias and more specifically methods and apparatuses for providing an interactive applications to a user along with a television broadcast.

### BACKGROUND

Television (TV) has traditionally been used as a one-way communication medium in which the television network decides what programs will be shown at what times. Even with these restrictions TV has proven to be the worlds most popular media delivery device. However, due to certain limitations, TV technology has not been cultivated to the extent that Personal Computer (PC) technology has. More specifically, various applications that are widely available for PCs are not useable via TV. For example, in the past if user interaction with a TV show was desired, either by polling the viewers for their opinions or the like, users would have to use a different communication medium such as a telephone to give their opinion. This is somewhat burdensome on users because they may not necessarily be close to their telephone. Therefore, interactivity with a show was limited to those users that wanted to call in. Opinions of other users that choose not to call in their opinion go left unheard. This may result in somewhat skewed poll results.

There are many other organizations that spend a great deal of money polling citizens about their opinions of various events and persons. For example, numerous campaign employees continually administer presidential approval polls in person and over the phone. It would be advantageous to administer the polls over the TV due to the large number of people that watch TV every day, but due to the one-way transmission nature of TV this has not yet been possible.

The technology of ITV has been developed in an attempt to allow a TV set to serve as a two-way information distribution mechanism. Features of an ITV accommodate a variety of marketing, entertainment, and educational capabilities. Typically, the interactive functionality is controlled by a “set-top” decoder box (“set-top box” or “STB”), which executes an interactive program written for the TV broadcast. The interactive functionality is often displayed on the TV's screen and may include icons or menus to allow a user to make selections via the TV's remote control or a keyboard.

The program interactivity may be optional. Thus, a user who chooses not to interact or who does not have interactive functionality included with the user's TV should not suffer any degradation or interruption in program content. In order to provide this option to users, a transparent method of incorporating interactive content into the broadcast stream that carries the program is employed. In the present disclosure, “broadcast stream” or “live broadcast” refers to the broadcast signal, whether analog or digital, regardless of the method of transmission of that signal, i.e. by antenna, satellite, cable, or any other method of analog or digital signal transmission.

One method of transparently incorporating interactive content into the broadcast stream is the insertion of “triggers” into the broadcast stream for a particular program. The insertion of triggers into a broadcast stream is known in the art. Program content in which such triggers have been inserted is sometimes referred to as enhanced program content or as an enhanced TV program or video signal.

Triggers may be used to alert a STB that interactive content is available. The trigger may contain information about available enhanced content as well as the memory location of the enhanced content. A trigger may also contain user-perceptible text that is displayed on the screen, for example, at the bottom of the screen, which may prompt the user to perform some action or choose amongst a plurality of options. Thus, a user with a TV that has interactive functionality may be prompted at the beginning of an enhanced TV program to choose between interactive and passive (non-interactive) viewing of the enhanced TV program. If the user chooses passive viewing, any further triggers contained in the enhanced TV program may be ignored by the STB and the user will view the program in a conventional way. However, if the user chooses the interactive option, then further triggers may be embedded in the enhanced TV program.

Triggers may be inserted into the broadcast stream at various points along the broadcast path. Triggers may be inserted into the broadcast stream before broadcast of the content by a broadcast station or any other media provider. Thus, these triggers would be part of the broadcast stream received by cable head ends and further distributed to TVs within homes. TVs are provided with interactive functionality by their associated STBs.

One common method for inserting data such as triggers into an analog video signal is the placement of that data into the unused lines of the video signal that make up the vertical blanking interval (VBI). Closed caption text data is a well known example of the placement of data in the VBI of the video signal. The closed caption text data is typically transmitted during line 21 of either the odd or even field of the video frame in a National Television Standards Committee (NTSC) format. Closed caption decoders strip the encoded text data from the video signal, decode the text data, and reformat the data for display, concurrent with the video data, on a TV screen. Such closed caption decoders process the text data separately from the video signal.

The Advanced Television Enhancement Forum (ATVEF) has defined protocols for Hypertext Markup Language (HTML)-based enhanced TV. These protocols allow the delivery of enhanced TV programs to STBs and other devices providing interactive functionality by various transmission means, including, but not limited to, analog, digital, cable, and satellite. For the NTSC format, ATVEF specifies the type of information that may be inserted into the VBI of the video signal and on which lines of the VBI that information may be inserted. ATVEF specifies line 21 of the VBI as the line for insertion of an “ATVEF trigger,” i.e. the information that the STB or other device with interactive functionality interprets to provide interactive features to the enhanced TV program. ATVEF-A triggers comprise a Universal Resource Locator (URL), which provides an Internet address from which interactive content may be downloaded, whereas ATVEF-B triggers themselves can contain interactive content.

While the advent of ATVEF triggers have provided a gateway to interactive television, the complete utilization of ITV and enhanced TV has not been fully realized. For example, the TV has not yet been exploited as a tool for creating an interactive user experience that corresponds to the broadcast. Rather, ITV and enhanced TV has been limited to providing triggers to other predetermined content. Various users cannot alter the predetermined content in different ways. Rather, one trigger when selected by two different users will result in the presentation of the same ITV content. ITV and enhanced TV has not been fully realized as an interactive medium through which each user can customize their own TV viewing experience.

### SUMMARY

The present invention is directed to solving these and other problems and disadvantages of the prior art. In accordance with certain embodiments of the present invention, a method for providing an ITV application is provided. Specifically, the method comprises the steps of:

receiving notification that a first trigger associated with interactive content has been actuated during a television broadcast;

identifying the interactive content;

identifying an application associated with the interactive content; and

simultaneously providing a user access to the application associated with the interactive content and displaying the television broadcast via a common medium.

The application may be related to the television broadcast such that when the user interacts with the application, the viewing experience of the broadcast is enhanced. More specifically, application data may be transmitted along with the broadcast and the application data can be applied to the application at a STB associated with the user such that the application and the broadcast are synchronized. This allows the user to not only interact with the application but customize the display while viewing the broadcast.

In accordance with one embodiment of the present invention, the application may comprise a polling application. The polling application may contain a number of questions, which may be related to the broadcast. The user is able to answer the questions by interacting with the application. When the user answers the question, the results of the answer can be sent back to the head end where the answer is compiled with the answers from the other users. Then poll results can be generated and sent back to each participating user as application data. The application data can be applied back into the application at the user's STB such that poll results can be presented to the user. The user may also be able to answer additional poll questions in a similar fashion. The poll questions may be related to the content being displayed on the broadcast.

In accordance with another embodiment of the present invention, the application may comprise a gaming application. The gaming application may be related to the content being broadcast. The gaming application may be played simultaneously between a plurality of users and coordinated at the broadcast head end. Furthermore, the gaming application may be related to the same content that is being broadcast.

In accordance with another embodiment, a system for delivering interactive applications is provided. The system generally comprises the following:

a receiver adapted to receive broadcasts from an external source;

a first trigger associated with an application, wherein the first trigger provides a user an option to choose one or more applications, and wherein the application is associated with the broadcast;

a processor for retrieving the chosen application when the first trigger is engaged; and

a display apparatus operable to present the application and the broadcast to the user simultaneously.

As used herein “content” includes any type of user-perceptible substance that can incorporate visual and/or audio media. Content is typically in the form of video media or static pages that can be viewed on a TV or the like by a user. Examples of content include, but are not limited to, a live broadcast that may be received from a satellite provider, a cable provider, or over free air, advertisements or information for certain products and/or services, recorded images, computer rendered images or other graphics, audio content, and so on.

The summary is not intended to provide an exhaustive description of all embodiments of the present invention. Namely, additional features and advantages of embodiments of the present invention will become more readily apparent from the following description, particularly when taken together with the accompanying drawings.

### BRIEF DESCRIPTION OF THE DRAWINGS

FIG. 1 is a block diagram depicting a broadcast and display system in accordance with embodiments of the present invention;

FIG. 2 is a screen shot depicting viewer poll options in accordance with embodiments of the present invention;

FIG. 3 is a screen shot depicting viewer poll results in accordance with embodiments of the present invention;

FIG. 4 is a screen shot depicting a welcome page for an interactive gaming application in accordance with embodiments of the present invention;

FIG. 5 is a screen shot depicting an instruction page for an interactive gaming application in accordance with embodiments of the present invention;

FIG. 6 is a screen shot depicting an interactive gaming application in accordance with embodiments of the present invention;

FIG. 7 is a screen shot depicting gaming application options in accordance with embodiments of the present invention;

FIG. 8 is a flow chart depicting a method of administering an interactive application with a TV broadcast in accordance with embodiments of the present invention;

FIG. 9 is a flow chart depicting a method of conducting a polling application in accordance with embodiments of the present invention; and

FIG. 10 is a flow chart depicting a method of conducting a gaming application in accordance with embodiments of the present invention.

### DETAILED DESCRIPTION

Embodiments of the present invention are generally directed toward methods and systems for administering ITV and creating an enhanced TV viewing experience. Although well suited for use with a television or similar type of display apparatus in conjunction with a STB, those skilled in the art can appreciated that embodiments of the present invention may also be implemented in conjunction with a simple television set not including a STB. Moreover, the systems and methods described in the present disclosure may be implemented in any media that may be enhanced through the use of events including, but not limited to, triggers that are synchronized to user-perceptible segments in a broadcast or other type of content.

As used herein “viewer” and “user” are used synonymously to refer to any person or thing that is currently making use of and/or interacting with the enhanced television system.

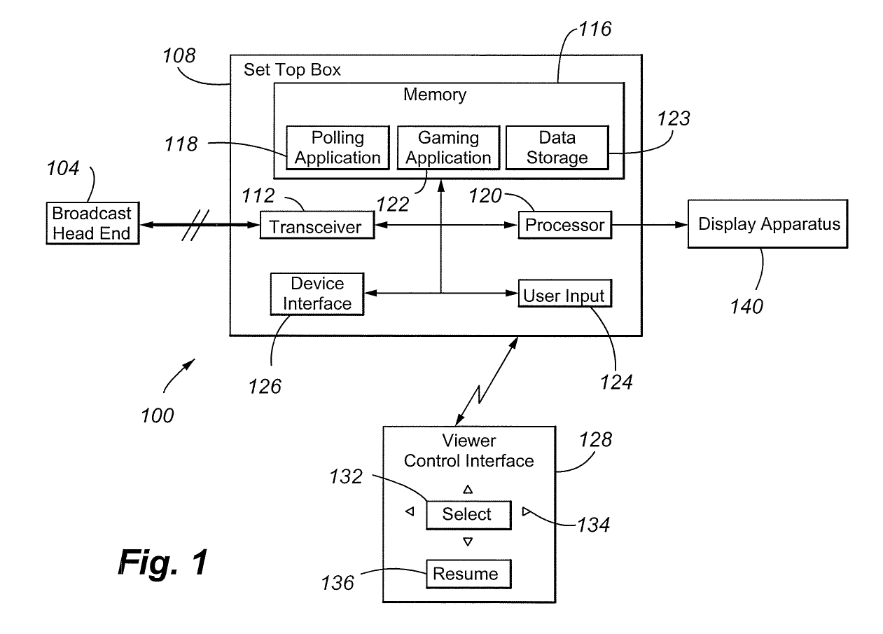

Referring now to FIG. 1, one embodiment of a hardware system 100 for providing interactive media will be described in accordance with embodiments of the present invention. The system 100 generally comprises a broadcast head end 104, a Set Top Box (STB) 108 comprising a transceiver 112, a memory 116 including at least a polling application 118 and a gaming application 122, a processor 120, a user input 124, a device interface 126, a viewer control interface 128 comprising a select button 132, navigation arrows 134, and a resume button 136, and a display apparatus 140. The broadcast head end 104 may be associated with one or more servers that provide information to and receive information from the broadcast head end 104. The broadcast head end 104 may alternatively be associated with a satellite uplink and/or an interactive TV transmission facility. Information that may be provided to the broadcast head end 104 includes live broadcast signals, triggers, content related to the triggers, raw data, images, and other streaming or non-streaming video and audio media.

The processor 120 may be implemented as a microprocessor or similar type of processing chip. The processor 120 may complete executable instructions or routines stored in a portion of memory 116. Alternatively, the processor 120 may be implemented in the form of an application specific integrated circuit (ASIC) that is operable to perform predefined functions based on predetermined inputs. The processor 120 generally functions to run programming code including operating system software, and one or more applications implementing various functions performed by the STB 108.

The memory 116 may be implemented as a volatile or non-volatile memory, or combinations thereof. For example, the memory 116 may comprise a temporary or long-term storage of data or processor instructions. The memory 116 may be used in connection with the presentation of enhanced content to a viewer. The memory 116 may comprise solid-state memory resident, removable or remote in nature, such as DRAM, SDRAM, ROM, and EEPROM.

The memory 116 may contain one or more applications for execution by the STB 108. Examples of such applications include, without limitation, the polling application 118 and the gaming application 122. Other examples of applications that may reside in memory 116 may include a shopping application, an advertising application, and so on. All of the data necessary to execute the applications 118, 122 may reside entirely on the STB 108. The head end 104 may update the applications 118, 122 periodically. To update the applications 118, 122, the head end 104 may determine that the display apparatus 140 is currently inactive and that the necessary bandwidth for a download of data to the memory 116 is available. The head end 104 may also transmit application 118, 122 updates to the STB 108 through the VBI at a slower rate.

Alternatively, some or all of the application data, including input data for the application 118, 122, may reside on a server associated with the broadcast head end 104. In one embodiment, execution of an application 118, 122 may require requesting and receiving application data from the head end 104 with the broadcast.

In another embodiment, the execution of the application 118, 122 may occur at the head end 104. Accordingly, control signals may be transmitted from the STB 108 to the head end 104 and results of the execution of the application may be transmitted to the STB 108 from the head end 104.

The memory 116 may further include a data storage area 123. The capacity of the data storage area 123 may vary depending upon the amount of data that is stored at the STB 108. The size of the data storage area 123 may be larger to accommodate the local execution of an application 118, 122 and to store additional content such as interactive advertisements, applications, music, recorded shows, and the like.

The user input 124 may comprise a receiver for communicating with the viewer control interface 128. The user input 124 may also comprise a keyboard, mouse, a conventional wired or wireless remote control such as TV remote control, a universal remote control, or the like such that the user can navigate content presented to him/her in a similar manner to navigating content on a computer. The viewer control interface 128 may also be used to interact with the applications 118, 122 in accordance with embodiments of the present invention.

The device interface 126 generally provides a communication interface between the STB 108 and portable hardware devices. The portable hardware devices can retrieve data stored on memory 116 and retain such data in their own memory. The device interface 126 can include any type of known device interface such as a Universal Serial Bus (USB) port. Any external hardware device may be equipped to connect to the STB 108 via the device interface 126 and communicate with the STB 108 using known protocols. The device interface 126 may also include any other type of known interface technology such as serial ports and/or parallel ports.

The STB 108 is operable to communicate with the broadcast head end 104 via the transceiver 112. The transceiver 112 is essentially the interface to the head end 104 for the STB 108. The transceiver 112 may comprise a coaxial cable connection, a USB port or other type of serial port, a modem, an Ethernet adapter, a satellite adapter, or the like. Content received at the transceiver 112 is communicated to the processor 120 and/or the memory 116. Content that may be transmitted to the STB 108 includes, but is not limited to, live broadcasts from cable, satellite, or radio waves, songs, application data, application results, recorded video and static images, computer rendered images, specialized advertisements, triggers, and the like. Typically, applications 118, 122, computer rendered images, and specialized advertisements are stored in the memory 116 when they are received at the transceiver 112. The content is typically stored in a particular address of the memory such that it can be easily retrieved at a later time. In normal operation, content or application 118, 122 updates are sent to the STB 108 during idle periods (i.e., when the user is not viewing a live broadcast). However, content can also be sent to the STB 108 during a live broadcast through one or more VBIs as packets of information that can be stored in memory 116 while the live broadcast is being displayed. The packets of information can then be stored in memory 116 (e.g., a buffer memory) and reconstructed by the processor 120.

A trigger usually contains an address, pointer, or some other sort of reference to the stored content or a live broadcast. When a user activates a trigger during a broadcast, the processor 120 uses the address of stored content associated with the trigger to retrieve the content from memory 116 or from a server associated with the head end 104. In the event that the content associated with the trigger is a live broadcast, then the trigger references the channel where the live broadcast can be found. Subsequently, the content can be displayed to a user via the display apparatus 140. Thus, multiple pre-stored contents can be maintained in the memory 116 for later display at the appropriate time or a user can navigate multiple live contents via triggers.

Generally, a trigger is transmitted along with a broadcast and both are displayed to a user via the display apparatus 140. A user is able to select the displayed trigger by pressing the select button 132 on the viewer control interface 128. The command to view content associated with the displayed trigger is received at the user input 124. The processor 120 registers the request, determines the address of the stored content in memory 116, and retrieves the associated content from the memory 116. Alternatively, the processor 120 registers the request and determines the address of the live broadcast content on another channel. Thereafter, the requested content is transmitted to the display apparatus 140 for presentation to the user.

A trigger can be transmitted with a broadcast, a live advertisement, and/or an interactive advertisement (e.g., a short form or long form advertisement). The trigger is used to begin interaction with one or more of the applications 118, 122 stored in memory 116 and/or on a server associated with the head end 104. The trigger may be displayed with content associated with a given application. For example, if the content being transmitted from the broadcast head end 104 is a football game or advertisement, then a trigger for a football related application, for instance a fantasy football gaming application, may be transmitted with such content. When selected, the trigger provides an indication that the given application 118, 122 should be retrieved and presented to the user.

In an alternative embodiment, content may not be stored in long-term storage portion of memory 116. Rather, the content may be transmitted along with the broadcast and the associated trigger. The application associated with the trigger may be stored in a memory buffer such that if the user activates the trigger associated with the application, the application (or an access to the application) can be displayed from the buffer. Otherwise, the application is purged from memory to make room for new applications. As can be appreciated, a combination of long-term and short-term memory may be utilized to store applications and other content associated with a trigger.

In accordance with at least some embodiments of the present invention, content associated with the trigger may be live content on a different channel. The trigger presented to the user may include a question asking the user if he/she would like to change channels. When the trigger is actuated, a portion of the display apparatus 140 is changed from the original channel to the new channel associated with the trigger. Furthermore, the original channel may continue to be displayed to the user in a smaller portion of the display apparatus 140.

In the event the user decides that he/she does not wish to engage the application 118, 122 associated with a particular trigger, the resume button 136 on the viewer control interface 128 may be activated to go back to the content that was previously being viewed. Thus, if the user was previously watching a television show when the trigger was activated, he/she may simply press the resume button 136 and the processor 120 will stop displaying the selected application and will resume displaying the previous content. Likewise, the user may navigate through different interactive applications 118, 122 and live broadcast content using the arrows 134 in conjunction with the select 132 and resume 136 buttons.

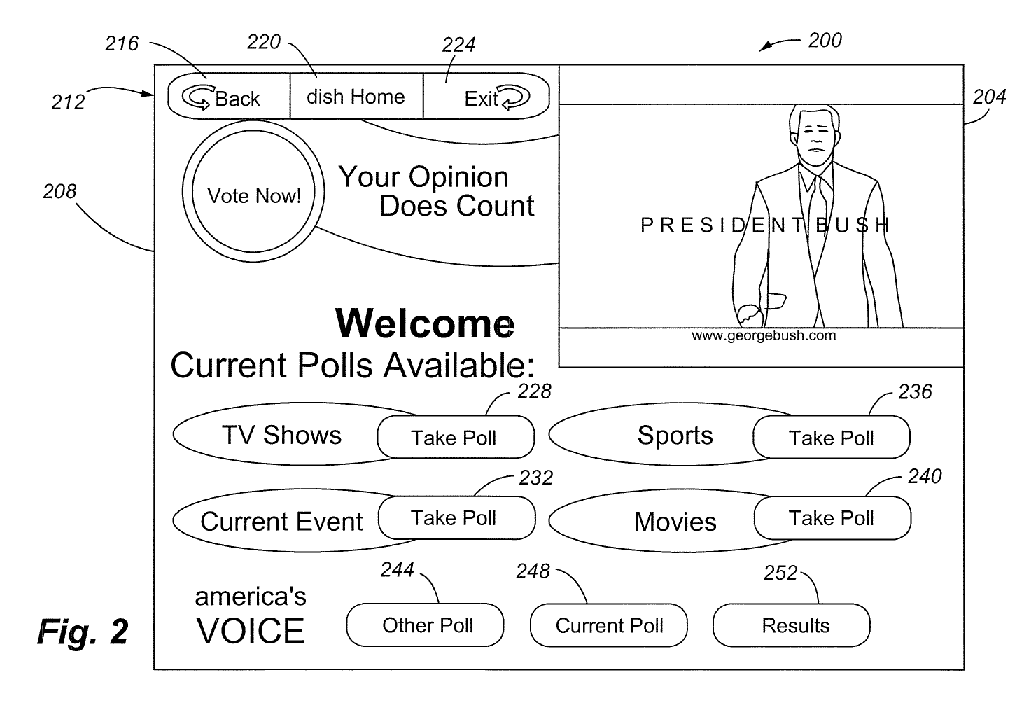

Referring now to FIG. 2, a polling application options screen 200 is depicted in accordance with at least some embodiments of the present invention. The interactive music menu 200 generally comprises a first portion 204 for displaying a broadcast signal and a second portion 208 for displaying content associated with the polling application 118. The first portion 204, in one embodiment, generally occupies about a quarter of the display apparatus 140 and the second portion 208 generally comprises the remainder of the display apparatus 140 although various proportions can be allocated for different portions depending upon the type of content to be displayed therein.

The second portion 208 may further include a high level navigation bar 212 that allows a user to easily navigate through high levels of the interactive application. For example, the high level navigation bar 212 may include a back selector 216, a home selector 220, and an exit selector 224. When the back selector 216 is selected, the content within the second portion 208 may return to content that immediately preceded the current content. The selection of the home selector 220 may change both the first and/or second portions 204 and 208 respectively back to their default (e.g., home) content. If the exit selector 224 is selected, then any content associated with the trigger, such as the applications 118, 122, may be removed from the display device 140 in exchange for a live broadcast. More specifically, transmission of an application and/or application data may be discontinued upon engaging the exit selector 224.

The second portion 208 can also include a number of triggers for interacting with the polling application 118. The triggers that may be provided on the polling application 118 options screen include, but are not limited to, a number of different polls selector triggers (e.g., TV show poll trigger 228, current event poll trigger 232, sports poll trigger 236, and movies poll trigger 240), other polls trigger 244, current poll trigger 248, and a poll results trigger 252. One or more of the polls selector triggers may be associated with the content currently being broadcast and displayed in the first portion 204. For example, if the broadcast is a show about the president of the United States, then a current events poll 232 may ask whether the user approves of the President's work. As another example, if the broadcast is a show where viewers are asked to cast their vote and their vote determines what show participants will stay and go, then the TV show poll 228 may ask the viewer to decide if the participant should remain on the show or not. In this way, the results of the poll almost immediately determine the outcome of the TV show.

The other poll trigger 244 may lead to another poll options screen where various other types of polls not shown on the first poll options screen reside. The current poll trigger 248 may lead to a highlighted poll of the day. The current poll trigger 248 may also be the trigger associated with the poll related to the broadcast. In one embodiment, the current poll trigger 248 comprises an address to a lookup table that identifies the type of content being broadcast and further identifies any poll related to the broadcast content. The lookup table may be stored in memory 116, in a server associated with the head end 104, or may be transmitted along with the broadcast. In this embodiment, the poll that is retrieved by selecting the current poll 248 changes as the broadcast content changes.

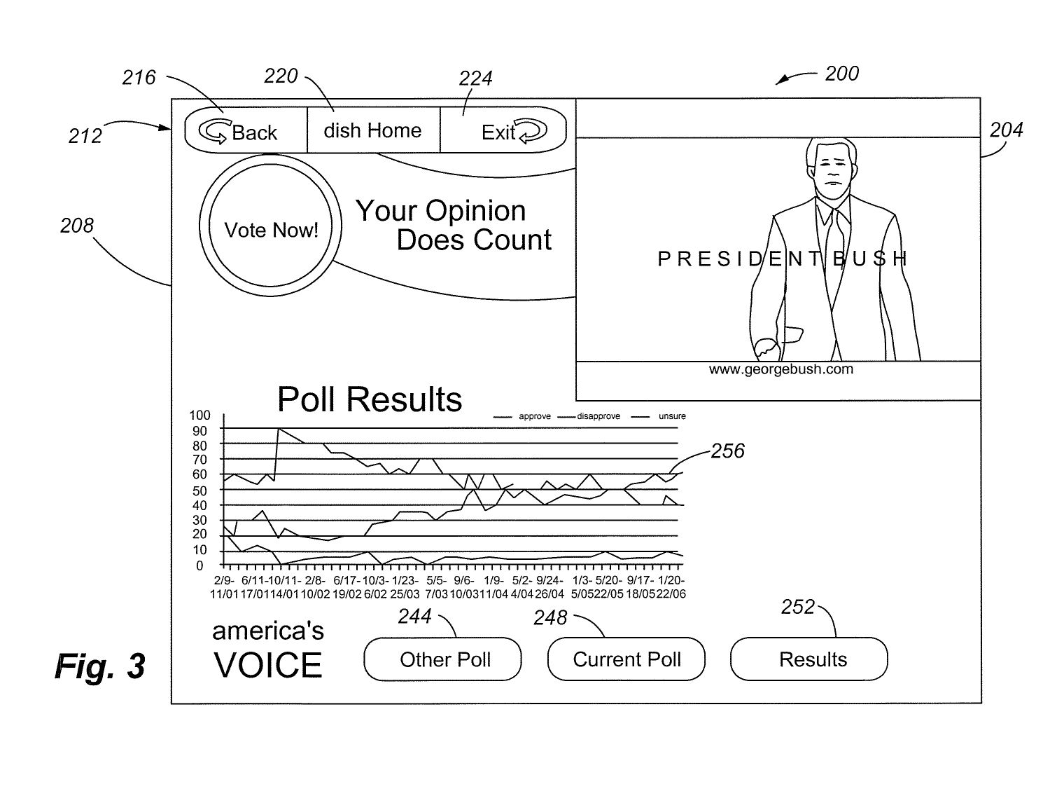

As can be seen in FIG. 3, results of the poll 256 may also be compiled and displayed for the user in the second portion 208 in accordance with at least some embodiments of the present invention. Participating in the poll may result in automatic access to such results. A user may alternatively access poll results 256 via the results trigger 252. The poll results may be updated as a vote is received at the head end 104. Therefore, the results may be dynamically updated. Alternatively, a snapshot of the results may be provided to the user, where the point-in-time associated with the snapshot is related to the point-in-time when the user selected the results trigger 252 or cast a vote.

In accordance with one embodiment, the head end 104 may transmit the poll results either continuously or periodically as raw data. The raw data may be used as input for the polling application 118, which renders the results display 256. Accordingly, the user may be able to manipulate how the polling application 118 displays the data (e.g., the chart type, chart dimensions, scale, etc.) since the polling application 118 is stored locally and the transmission from the head end 104 is raw data. The poll results 256 may be displayed in a number of different forms such as in a table format, as a pie chart, line chart, bar chart, or any other viewable chart.

In accordance with an alternative embodiment, the poll results 256 may be generated into a predetermined results format and transmitted to all viewers in the same format. In this embodiment, the polling application 118 may only be needed to interface with the head end 104 where the application is being executed. More specifically, the polling application 118 may be used to transmit a poll answer or a request for poll results and may not be necessary for manipulation of raw data.

In accordance with embodiments of the present invention, various poll questions may be generated and given to a user during the course of a broadcast. The poll questions may be updated to reflect what is occurring in the broadcast. For example, if the broadcast is a football game, then questions at the beginning of the game may include, “Who will win this game?” and “How many points will be scored?” Whereas questions in middle of the game may include, “Will team X score a touchdown on this drive?” and “Will the next play be a passing play or a running play?” The poll questions may further be incorporated into a gaming type application whereby the STB 108 or a server associated with the head end 104 may track each user's answers and declare a winner at the end of the broadcast.

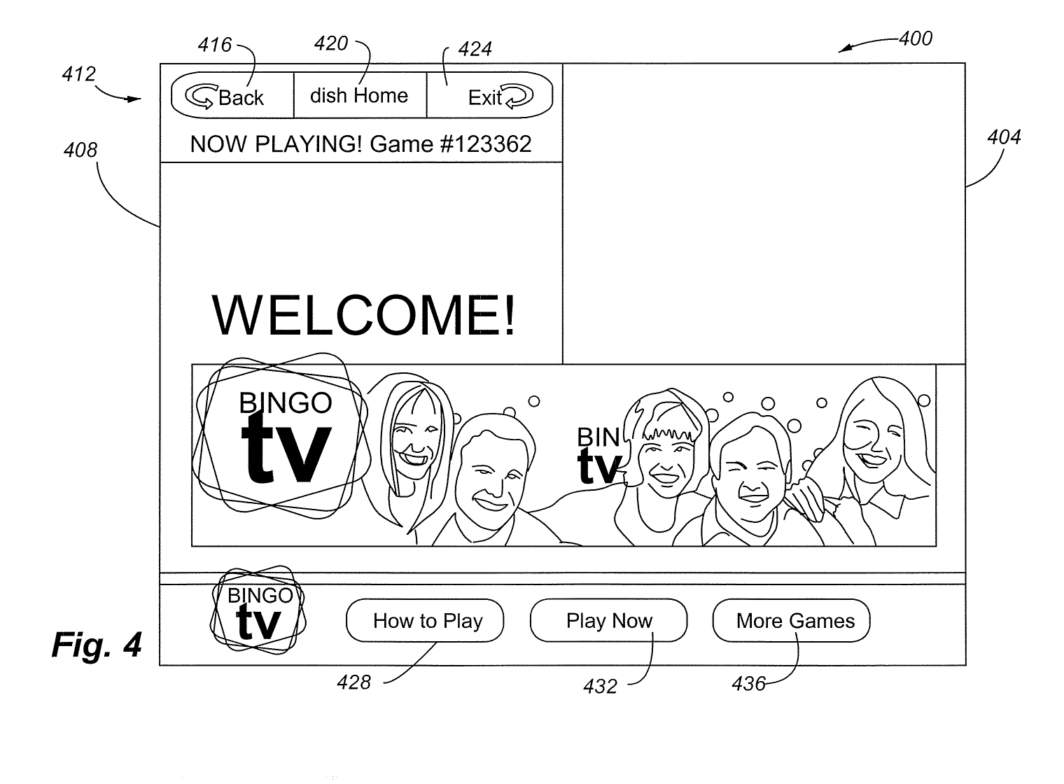

FIG. 4 depicts a gaming application screen 400 in accordance with embodiments of the present invention. More specifically, the gaming application screen 400 may present the user with a welcome page for the gaming application 120. The gaming application screen 400 may include a first portion 404 and a second portion 408. The first portion 404 is similar to the first portion 204 of the polling application 118 in that it may be used for displaying a broadcast signal or other live transmission. The second portion 408 may be used for displaying content associated with the gaming application 122. The first portion 404, may occupy about a quarter of the display apparatus 140 and the second portion 408 may occupy the remainder of the display apparatus 140 although various proportions can be allocated for different portions depending upon the type of content to be displayed therein.

The second portion 408 may include a navigation bar 412 similar to the navigation bar 212 provided in the polling application 118. The navigation bar 412 may include a back selector 416, a home selector 420, and an exit selector 424. The functions associated with each selector 416, 420, and 424 are similar to the functions of the selectors in the navigation bar 212 provided in the polling application 118.

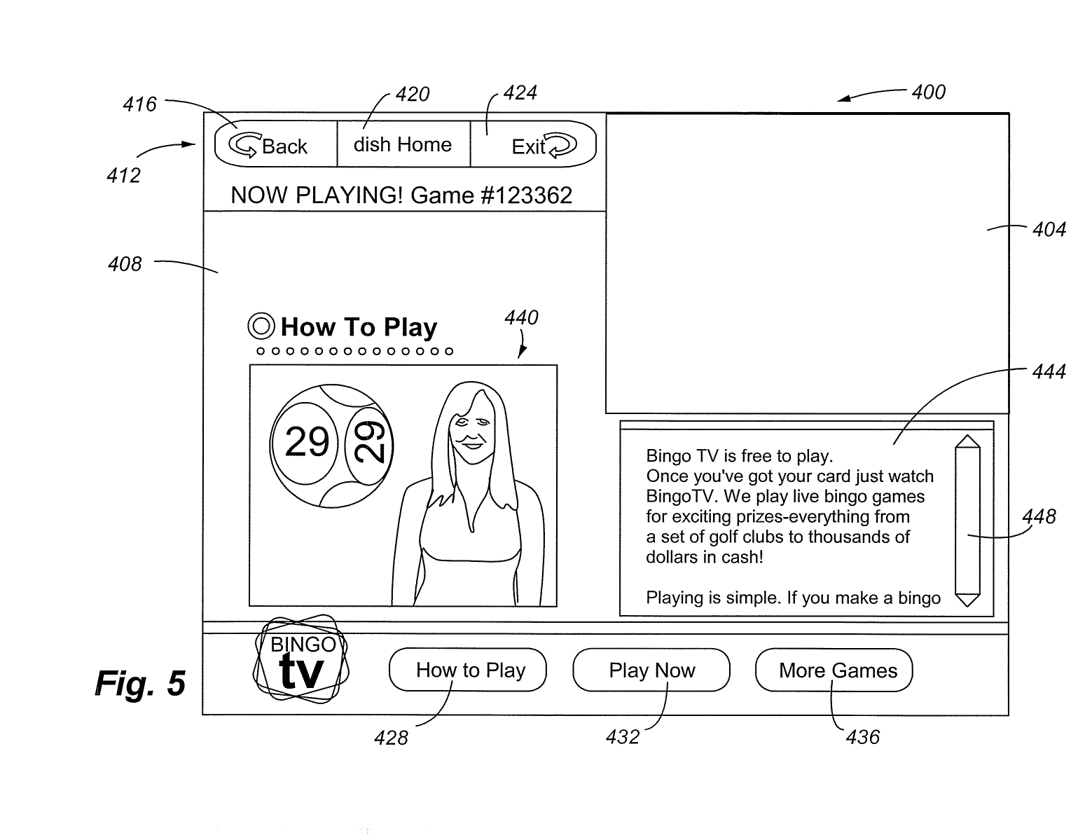

The second portion 408 may also include a number of triggers for interacting with the gaming application 122. The triggers that may be provided on the gaming application 118 options screen include, but are not limited to, a how to play trigger 428, a play now trigger 432, and a more game options trigger 436. The how to play trigger 428 is associated with an instructions page. As can be seen in FIG. 5 when the how to play trigger 428 is engaged, the second portion 408 of the screen may be populated with a video instruction section 440 and a written instruction section 444. A user can view the video instructions 440 and/or read the written instructions 444 in order to learn how to participate in a given game application 122. The written instruction section 444 may further include a scroll bar 448 for navigating the written instruction section 444. Each button (i.e., the up and down button) on the scroll bar 448 may correspond to a different trigger, which may be engaged by the user via the control interface 128. There may be a different how to play screen for each type of gaming application 122 available to the user.

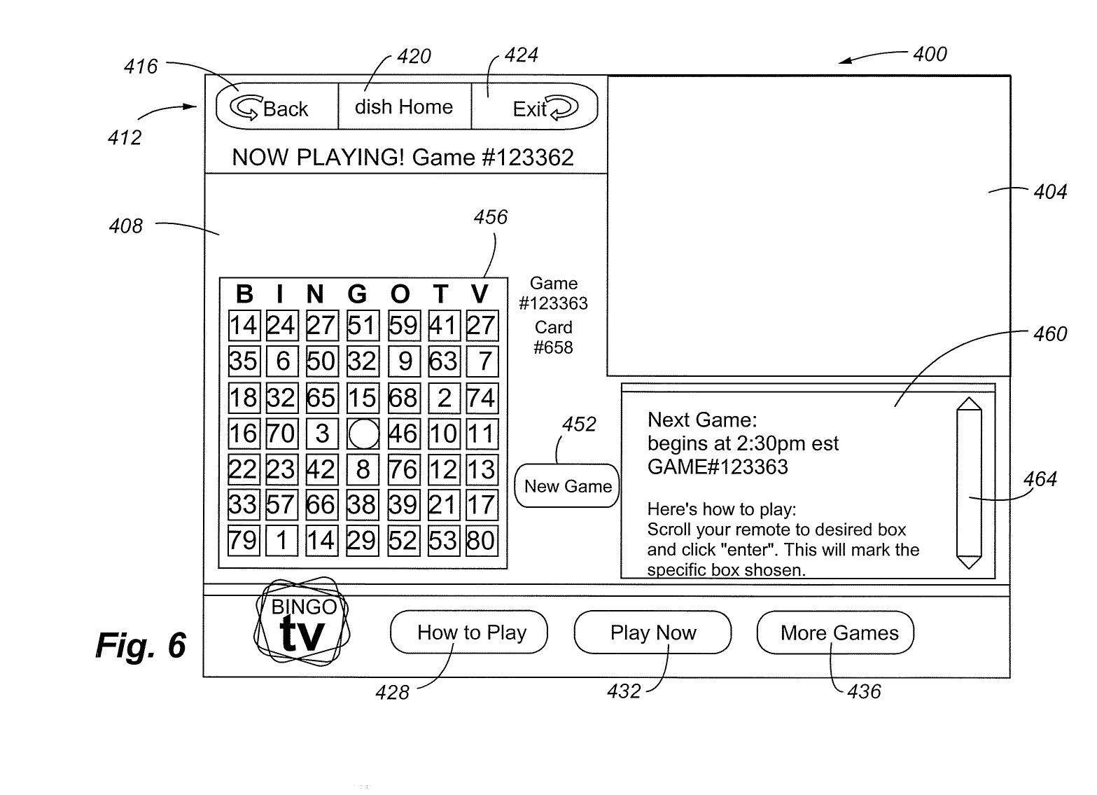

Referring now to FIG. 6, an interactive screen for participating in a game via the gaming application 122 is depicted. The game can be accessed by engaging the play now trigger 432. Upon selecting the play now trigger 432 the second portion 408 may be updated to show the game interface 456. For example, if the game is bingo, then game interface 456 may comprise a bingo card. Alternatively, if the game is for some fantasy sport related to the broadcast (e.g., fantasy basketball), then the game interface 456 may depict the user's fantasy team and each player's respective points accrued through the game. As data is updated at the head end 104, the data may be transmitted to the STB 108 and used as input to update the game interface 456 accordingly. For instance, as bingo numbers are called out, the selected bingo number may be transmitted to the STB 108 and the game interface 456 may be updated. The raw data transmitted may also comprise messages that can be displayed in the game interface 456, such as “Bingo Called” when another user has made bingo. This way each user can be apprised of what other users are doing with respect to the game.

One unique aspect of the present invention is that the gaming application may not only be related to the broadcast but that it may be synchronized with the broadcast. For example, as events occur in the broadcast data may be transmitted to update the game interface 456 thereby making the viewing of the broadcast an interactive experience. The interaction with the broadcast may be common to all viewers or may be unique to each viewer depending upon preferences of the user. One example of how the viewing experience may be unique to each user is in the case of a fantasy baseball game where each user may have a different team of players and therefore each user's screen is updated to reflect the user's team performance. Of course, the user may also be provided with information related to the performance of another user's team.

When the user is done with a particular game, for example when another user has called bingo, then the user may engage the new game trigger 452 to begin a new game and possibly join another set of users. Of course, the user may be able to play a game as a single user or against a computer-simulated user. There is no requirement that the user engage in a gaming application 122 where multiple users are needed. When the new game trigger 452 is engaged, the game interface 456 may be reset and a signal may be transmitted to the head end 104 indicating that a new game is desired.

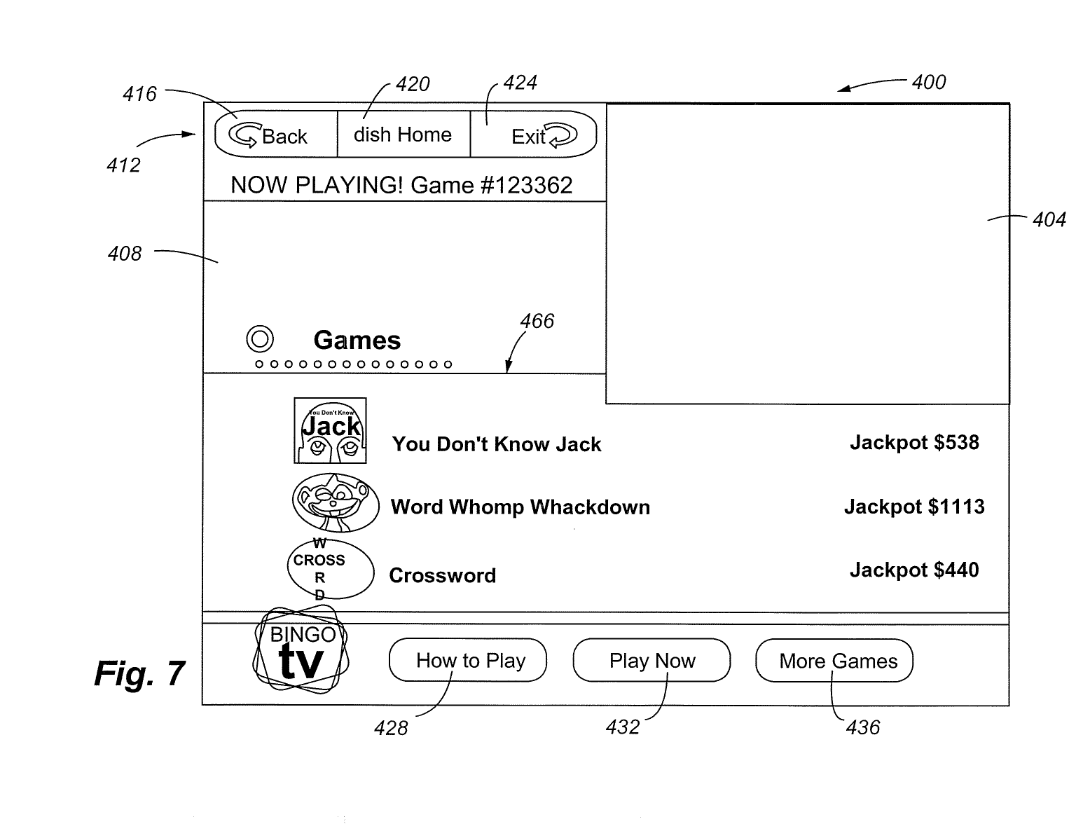

FIG. 7 depicts a game applications options depicting on the gaming application screen 400. When the more games trigger 436 is engaged, the second portion 408 of the screen may be populated with various gaming options for the user. The gaming options may be presented in an options menu 466 which may include a number of different gaming options 468, 476, 484. Gaming options 468, 476, 484 may include games of trivia, guessing, skill, or chance. Each gaming option may also include a prize for winning which may be displayed as a jackpot field 472, 480, 488 for each gaming option 468, 476, 484 that has the possibility of a prize. The user may select the gaming option based on the game that is most desirable or based on the prizes available for each game. The gaming options displayed may correspond to those gaming applications 122 currently available on memory 116. The gaming options may be updated on the memory 116 by periodic application downloads by the head end 104. In an alternative embodiment, each of the gaming options may be those games not currently stored on memory 116 and the selection of a game trigger 468, 476, 484 may result in the STB 108 sending a request for a game download from the head end 104. Upon receiving the request for a particular game application 122, the head end 104 may begin transmitting the application to the STB 108 for storage on the memory 116. Once the gaming application 122 is properly stored on memory 116, the user may be able to participate in the selected game.

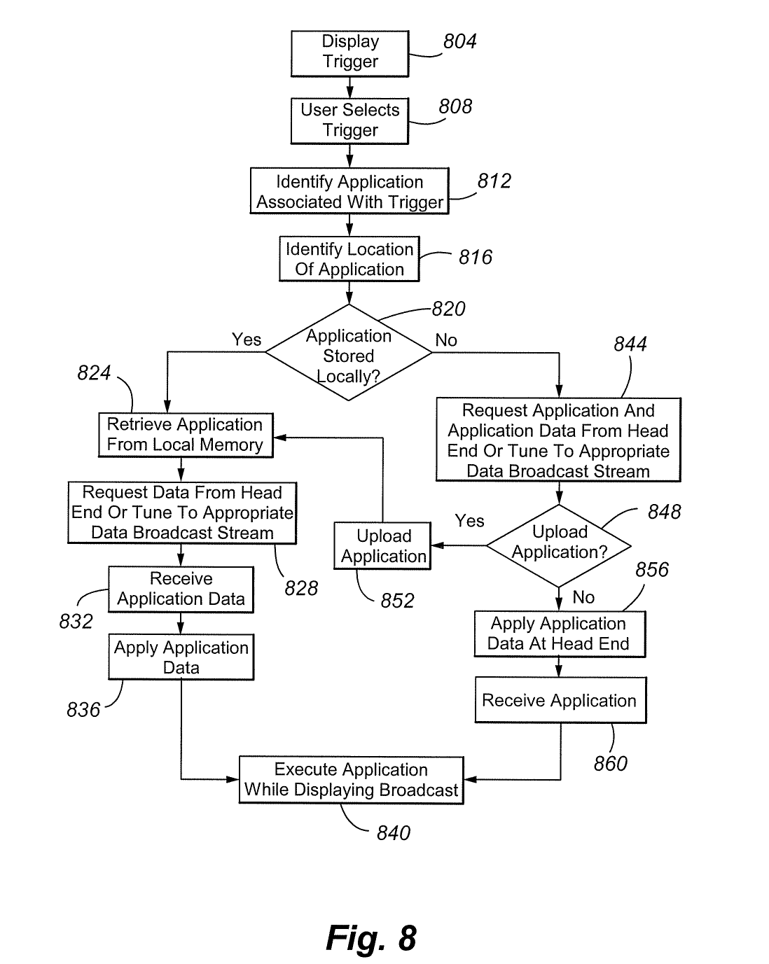

With reference to FIG. 8, a method of administering an interactive TV application 118, 122 will be described in accordance with at least some embodiments of the present invention. The method begins when a trigger is displayed (step 804). The trigger may be displayed during a broadcast, a broadcast advertisement, a short form advertisement, a long form advertisement, and so on. The display of triggers is described more fully in U.S. patent application Ser. No. 11/425,652, the entire contents of which are incorporated herein by this reference. The trigger displayed may be presented during enhanced content of an advertisement or may be embedded as a part of the broadcast content. The trigger 804 may therefore be related to the content currently being displayed.

The user can select the trigger and go interactive with the associated application 118, 122 (step 808). To select the trigger, the user may engage the select button 132 on the viewer control interface 128. If the user does not wish to interact with an interactive application, then the user is not required to select the displayed trigger. However, once the user selects the trigger, the application 118, 122 associated with the trigger is identified (step 812). The trigger typically comprises an in-memory address, either on the STB 108 or on a server associated with the head end 104. When the trigger is selected, the processor 120 searches the associated address and determines the location of the application 118, 122 (step 816). The application 118, 122 may actually be stored in the address from the trigger. Alternatively, the address from the trigger may contain information for either locating the application 118, 122 from local memory 116 or for requesting the application 118, 122 from the head end 104. Thus, the processor 120 determines whether the application 118, 122 is stored locally or remotely based on information provided by the trigger (step 820).

In the event that the application 118, 122 is stored locally, then the processor 120 retrieves the application 118, 122 from local memory 116 (step 824). As a part of retrieving the application 118, 122 from local memory 116, the processor 120 will generate an initial display for the user but will also determine what further data is necessary to populate the display. In other words, the processor 120 will identify what type of data is required to fully execute the selected application 118, 122.

After the application 118, 122 has been retrieved, the processor 120 will generate and send a request for data to the head end 104 or time to the appropriate data broadcast stream (i.e., collect data from another TV channel) (step 828). The request for data may be a specific request for data or may be an indication that a particular application 118, 122 has been activated and all data related to the activated application 118, 122 is required. Upon receiving the request for data, a server associated with the head end 104 will begin transmitting the data to the STB 108. The STB 108 receives the transmitted data and forwards the data to the processor 120 (step 832). The processor 120 then applies the data to the selected application and completes the display for the user (step 836). One advantage of maintaining the application 118, 122 locally is that bandwidth is only required to transmit raw data to the STB 108 instead of results of executing the application at the head end 104.

The raw data is transmitted to the STB 108 where the execution of the application is performed. This allows the user to view a broadcast simultaneously while executing an application. Furthermore, a user has the discretion to decide how the application 118, 122 presents the data since the execution is performed locally. As data is updated at the head end 104 it is transmitted to the STB 108 such that the application can be updated to reflect the changed data. More specifically, the head end 104 may automatically collect votes, polls, game results, and so on and send that data via a live data stream to the STB 108. The processor 120 can incorporate the received data into the broadcast and present the application while simultaneously presenting the broadcast (step 840). This further allows the option of engaging in an application 118, 122 that is synchronized to the broadcast, thereby enhancing the broadcast viewing experience as perceived by the user. As a part of executing the application 118, 122 at the STB 108, user input may be sent back to the head end 104 via a return channel system. The user input may be used to update polls or games and provide other information to the head end 104 such as user information.

Of course, in an alternative embodiment, memory 116 space may be limited, and therefore some applications 118, 122 may be stored in association with the head end 104 to preserve memory 116 space. Referring back to step 820, if it is determined that the application is not stored locally, then the processor 120 issues a request for the application and application data from the head end 104 or tunes to the appropriate broadcast stream if the broadcasts stream contains the desired application (step 844). Upon receiving the request, it is determined whether the application 118, 122 will be uploaded to the STB 108 memory 116 or whether the application 118, 122 will be executed at the head end 104 and results of the execution of the application 118, 122 will be transmitted to the STB 108 (step 848). If the application 118, 122 is to be uploaded to the STB 108, then the head end 104 begins transmitting the application 118, 122 in packets along with the broadcast (e.g., in the VBI of the broadcast) until the application 118, 122 is successfully uploaded by the STB 108 (step 852). Or the receiver can tune to the appropriate broadcast data stream to access the required application. Thereafter, the method can continue with the application 118, 122 stored locally in step 824.

However, if the application 118, 122 is not going to be uploaded, then the application data is applied directly to the application 118, 122 at the head end 104 (step 856). Thereafter, the head end 104 sends results of the application with the application data inserted therein to the STB 108 where it is received (step 860). There is substantially more data transmitted when the application data is applied at the head end 104 as compared to just transmitting the application data. Therefore, the transmission of the entire application may require more time than simply transmitting raw data, which means that the user or the application 118, 122 will have to be more tolerant to delays. Once the application is received at the STB 108, the application is executed and presented to the user along with the broadcast (step 840).

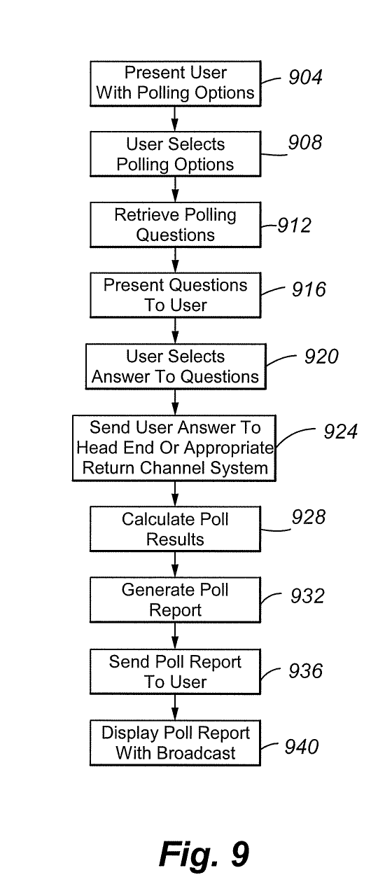

FIG. 9 depicts a method of conducting a polling application 118 in accordance with at least some embodiments of the present invention. Initially, a user is presented with polling options (step 904). The type of polling options that may be presented to the user include types of polls the user can participate in and whether the user wants to participate in any polls. The user is then able to select a polling option by selecting an associated trigger using the viewer control interface 128 (step 908). When the trigger is selected for a given poll, the processor retrieves the polling questions (step 912). The polling questions may be pre-stored on the memory 116 along with the polling application 118. Alternatively, the processor 120 may need to submit a request for the questions from the head end 104. Upon receiving the request, the head end 104 can generate the questions and transmit the questions to the STB 108 as application data.

After the processor 120 retrieves the poll questions, a poll is created according to the polling application 118 and presented to the user (step 916). The poll questions may be presented to the user in multiple-choice format or as a user fillable entry space. The user can than answer the poll question by selecting one of the multiple-choice answers or by entering an answer. In one embodiment, multiple-choice answers are provided that contain triggers to other locations of memory. Accordingly, the next screen that is displayed to the user may depend upon the answer/trigger that is selected.

When the answer is selected, the processor 120 transmits the user's answer to the head end 104 or the appropriate return channel system associated with a given channel rather than the head end 104 in general (step 924). The answer may be transmitted via a return channel, via a separate IP network, or some other known medium. The head end 104 receives the user's answer and calculates the poll results including the user's answer with all other received answer (step 928). Based on the results, the head end 104 generates raw data reflecting the poll results (step 932). The poll results data may be in a report format or raw data in a spreadsheet format. The raw data can then be transmitted back to the STB 108 associated with the user that just selected the answer (step 936). Additionally, the updated results may be transmitted to all other users currently participating in the same poll. This way all users are updated when another user enters their answer to the poll question.

After the user's STB 108 receives the updated poll results, the polling application 118 applies the poll results to the polling application and presents the poll results 256 to the user or updates the poll results 256 for the user if the user was already viewing the poll results (step 940). The poll results 256 may be displayed along with the broadcast. This feature is useful especially in circumstances where the poll is synchronized with the broadcast and poll questions are updated continually based on what is occurring in the broadcast.

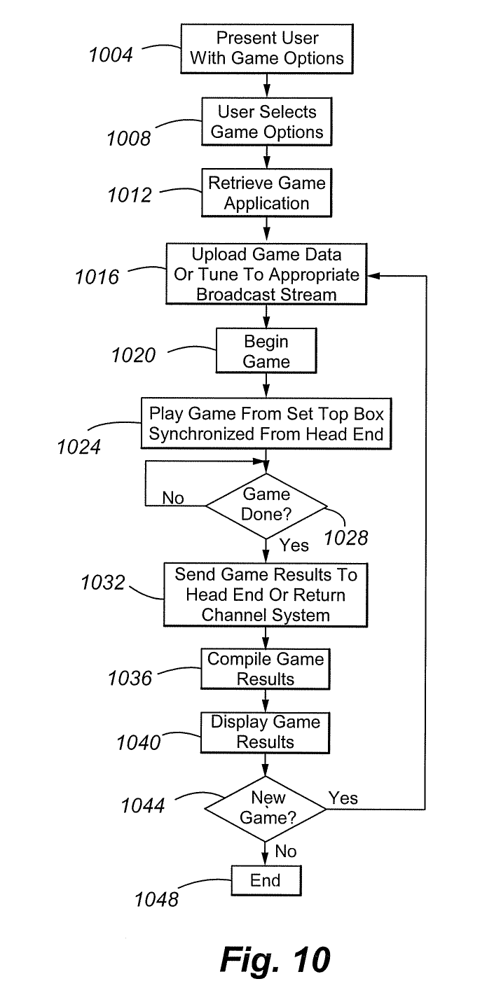

FIG. 10 is a flow chart depicting a method of conducting a game application 122 in accordance with at least some embodiments of the present invention. The method begins when a user is presented with game options (step 1004). The game options may include game applications 122 that are available locally as well as those that may be downloaded or broadcast from the head end 104. The user can then select a game application 122 from the options menu 466 by engaging a trigger associated with the game application 122 (step 1008). When the game application 122 is selected, the processor 120 retrieves the game application 122 either from local memory 116 or from the head end 104 (step 1012). Upon retrieving the game application 122, any necessary game data is uploaded to the STB 108 from the head end 104 or the STB 108 is tuned to the appropriate broadcast stream (step 1016). The type of game data that may be uploaded to the STB 108 includes, but is not limited to, the number of other users in the game, the data required to play the game (e.g., bingo card and numbers or fantasy player identification information), and the game rules.

With the game data uploaded, the user can begin the game (step 1020). The user is then able to play the game from the STB 108, while the broadcast is displayed. The game may also be synchronized with the broadcast from the head end 104 (step 1024). The synchronization of the broadcast and the application is made possible by the simultaneous transmission of game data as it is updated along with the broadcast signal.

The user is allowed to play the game until the game is complete or the user is finished playing the game (step 1028). When it is finally determined that the user is done with the game, then the game results are sent to the head end or associated return channel system that then delivers the appropriate data to the head end system 104 or to the return channel system (step 1032). Of course, the STB 108 may have been sending data to the head end 104 while the game was being played so that the game data could be updated for all other users. The game results may be transmitted via a return channel.

A server associated with the head end 104 collects the game results from all users that were participating in the game and compiles the game results (step 1036). The compilation of the game results may determine which user was the winner of the game and other game statistics.

After the game results have been compiled, the game results are transmitted back to the STB 108 of the user, applied to the game application 122, and displayed to the user (step 1040). This allows the user to receive feedback on their performance in the game both individually as well as compared to other users that were playing the game.

Once the game results have been displayed to the user, it is determined whether the user wants to participate in another game (step 1044). This question may be answered affirmatively if the user selects the new game trigger 452. Alternatively, the user may elect not to participate in another game and may therefore select the home selector trigger 420. In the event that the user wants to play another game, the method returns to step 1016 and new game data is uploaded to the STB 108. However, if the user does not wish to play any further games, then the method ends (step 1048).

As can be appreciated by one of skill in the art, participation in an application 118, 122 may be free of charge. Alternatively, there may be a cost associated with using an application 118, 122. The charges may be incurred periodically as a part of the television service provider's bill or they may be incurred on a pay-per-use basis.

The foregoing discussion of the invention has been presented for purposes of illustration and description. Furthermore, the description is not intended to limit the invention to the form disclosed herein. Consequently, variations and modifications commensurate with the above teachings, within the skill and knowledge of the relevant art, are within the scope of the present invention. The embodiments described hereinabove are further intended to explain the best modes presently known of practicing the invention and to enable others skilled in the art to utilize the invention in such, or in other embodiments, and with the various modifications required by their particular application or use of the invention. It is intended that the appended claims be construed to include alternative embodiments to the extent permitted by the prior art.

What is claimed is:

1. A method of providing an interactive program, comprising:
receiving notification that a first trigger associated with interactive content has been actuated during a television broadcast;
identifying the interactive content;
identifying an application associated with the interactive content; and
simultaneously providing a user access to the application associated with the interactive content and displaying the television broadcast via a common medium.

2. The method of claim 1, further comprising:
transmitting application data from a broadcast head end to a Set Top Box (STB) associated with the user;
receiving the application data at the STB; and
applying the application data to the application associated with the interactive content at the STB.

3. The method of claim 2, further comprising allowing the user to alter aspects of the display of the application data by interacting with the application associated with the interactive content.

4. The method of claim 2, wherein the application data is transmitted during Vertical Blanking Intervals (VBIs) of the broadcast.

5. The method of claim 1, further comprising:
the user interacting with the application;
transmitting results of the interaction from a STB to a broadcast head end;
compiling the results at the head end;
updating application data; and
transmitting the updated application data from the broadcast head end to at least the STB associated with the user.

6. The method of claim 5, wherein compiling comprises combining the results of the user interaction with results of other user interactions.

7. The method of claim 6, wherein transmitting the updated application data comprises transmitting the updated application data to STBs associated with each of the other users that have interacted with the application.

8. The method of claim 1, further comprising:
determining the type of content currently being broadcast;
identifying application data that is related to the type of content currently being broadcast; and
transmitting the related application data from a broadcast head end to a STB associated with the user.

9. The method of claim 1, wherein the application comprises a polling application and the application data comprises polling data.

10. The method of claim 9, further comprising:
presenting poll questions to the user;
receiving an answer to the poll questions;
calculating poll results;
generating a poll report; and
sending the poll report to the user.

11. The method of claim 10, wherein the poll report comprises a compilation of answers from a plurality of users that have answered the same poll questions.

12. The method of claim 1, wherein the application comprises a game application and the application data comprises game data.

13. The method of claim 1, further comprising:
determining that the application associated with the interactive content is not stored locally;
applying application data with the application at a broadcast head end; and
transmitting results to the user.

14. The method of claim 1, further comprising:
determining that the application associated with the interactive content is not stored locally; and
requesting at least one of the following:
(i) that the application associated with the interactive content be downloaded to a STB associated with the user; and
(ii) that the STB tune to the appropriate data stream broadcast to access the requested application.

15. The method of claim 14, further comprising downloading the application to the STB during VBIs of the broadcast.

16. The method of claim 14, further comprising downloading the application to the STB during an idle period.

17. A computer readable medium comprising processor executable instructions for performing the method of claim 1.

18. An enhanced television system, comprising:
a receiver adapted to receive broadcasts from an external source;
a first trigger associated with one or more applications, wherein the first trigger provides a user an option to choose the one or more applications;
a processor for retrieving the application when the first trigger is engaged; and
a display apparatus operable to present the application and the broadcast to the user simultaneously.

19. The system of claim 18, further comprising a memory for storing the application.

20. The system of claim 19, wherein the processor is operable to receive application data along with the broadcast and apply the application data to the application prior to presenting the application to the user.

21. The system of claim 20, wherein the user alters the presentation of the application data by controlling the processor.

22. The system of claim 20, wherein the application data is transmitted during Vertical Blanking Intervals (VBIs) of the broadcast.

23. The system of claim 18, wherein the receiver is further operable to transmit results of the user interacting with the application back to a broadcast head end where the results are compiled with results from other users who have interacted with a similar application.

24. The system of claim 23, wherein the broadcast head end is further operable to transmit the compiled application data back to the receiver, and wherein the receiver is operable to forward the compiled application data to the processor such that the processor can apply the compiled application data to the application and update the presentation of the application.

25. The system of claim 18, further comprising a second trigger embedded within the application that allows the user to interact with the application.

26. The system of claim 25, wherein the at least one of the first and second trigger comprises at least one of a Universal Resource Locator (URL) that provides an address from which the application can be found.

27. The system of claim 26, wherein the address comprises a memory address.

28. An apparatus for providing an interactive program, comprising:
means for receiving a broadcast;
a first trigger means associated with a first user engageable application, wherein the first trigger means provides a user an option to choose to engage with the first application;
processing means for retrieving the first application from at least one of local and external memory when the first trigger means is selected by the user; and
display means operable to present the application and the broadcast to the user at substantially the same time.

29. The apparatus of claim 28, further comprising a second trigger means embedded within the first application, wherein the second trigger means is associated with a second user engageable application.

30. The apparatus of claim 29, wherein at least one of the first and second applications are related to the broadcast.
